(19) United States
(12) Patent Application Publication
(10) Pub. No.: US 2009/0205542 A1
(43) Pub. Date: Aug. 20, 2009

(54) Flameproof container

(76) Inventor: Chih-Ping Chang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/071,293

(22) Filed: Feb. 20, 2008

(51) Int. Cl. B65D 81/38; E05G 1/024; E05G 1/026

(52) U.S. Cl. 109/23; 220/600; 220/810; 109/64

(57) ABSTRACT

A flameproof container includes a box body, with an accommodation space therein; and a lid covering the box body. The box body and the lid are made of flameproof material. The box body and the lid respectively have an inner cushion therein. An outer cladding covers each of the box body and the lid. The outer cladding is a flameproof cloth. The accommodation space is used to hold small valuable goods.

### BACKGROUND OF THE INVENTION

1. Field of the Invention

The invention generally relates to a flameproof container for enclosing and protecting small delicate goods.

2. Description of the Related Art

In a fire disaster, small delicate and valuable goods such as cash bills or jewelry are lost because of failure of timely protecting them.

A conventional flameproof container is made of metal. However, it is not very convenient to use and carry due to its heavy weight and high cost.

A waterproof, flameproof and anti-magnetic wave container has been proposed to include a container with a metallic cover and a flameproof layer. However, its heavy weight and high cost still lead to inconvenience in use.

Therefore, there is a need of a flameproof container which has overcome the prior problems.

### SUMMARY OF THE INVENTION

An object of the invention is to provide a flameproof container with light weight and low cost, which is easy for the user to use and carry.

In order to achieve the above and other objectives of the invention, the flameproof container includes a box body with an accommodation space therein; and a lid covering the box body. The box body and the lid are made of flameproof material and respectively have an inner cushion therein. An outer cladding covers each of the box body and the lid. The outer cladding is a flameproof cloth.

The invention also provides a flameproof container which includes a box body and a lid. The box body has an accommodation space therein. One side of the lid is pivotally connected to one side of the box body. A suspender is connected between the lid and the box body to lead the lid to leave or cover the box body. The box body and the lid are made of flameproof material and respectively have an inner cushion therein. An outer cladding covers each of the box body and the lid. The outer cladding is a flameproof cloth.

The invention further provides the following advantages. The box body and the lid are made of flameproof material, which contribute to light weight and low cost for the flameproof container. Furthermore, tan outer cladding covers each of the box body and the lid, providing further fireproof to the container.

To provide a further understanding of the invention, the following detailed description illustrates embodiments and examples of the invention, this detailed description being provided only for illustration of the invention.

### BRIEF DESCRIPTION OF THE DRAWINGS

FIG. 1 is an exploded view of a flameproof container according to one embodiment of the invention;

FIG. 2 is a perspective view of a flameproof container according to one embodiment of the invention;

FIG. 3 is a schematic cross-sectional view of a flameproof container according to one embodiment of the invention; and

FIG. 4 is a perspective view of a flameproof container according to another embodiment of the invention.

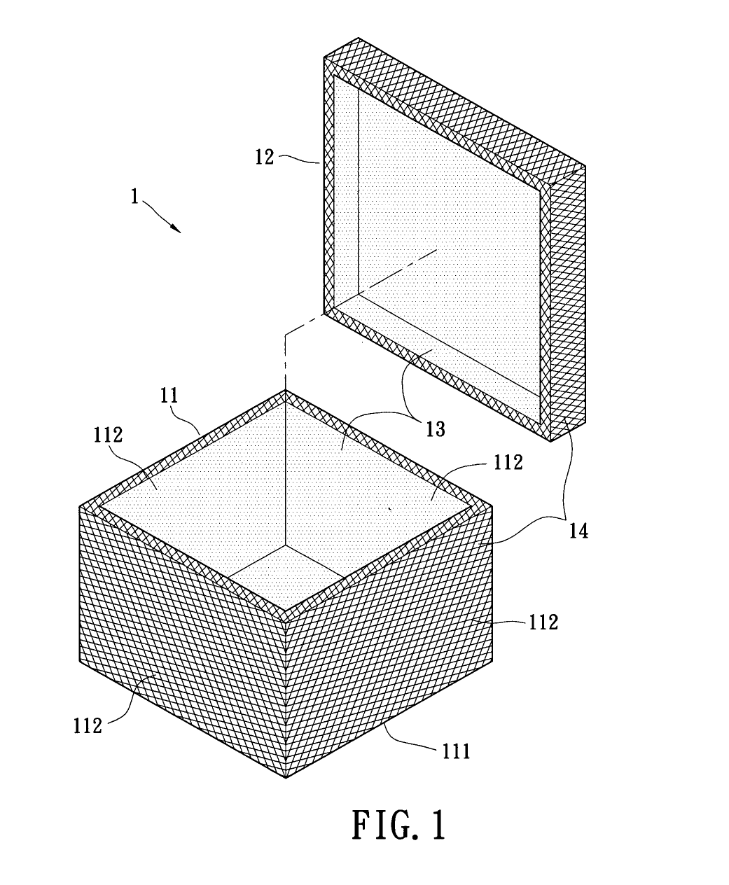

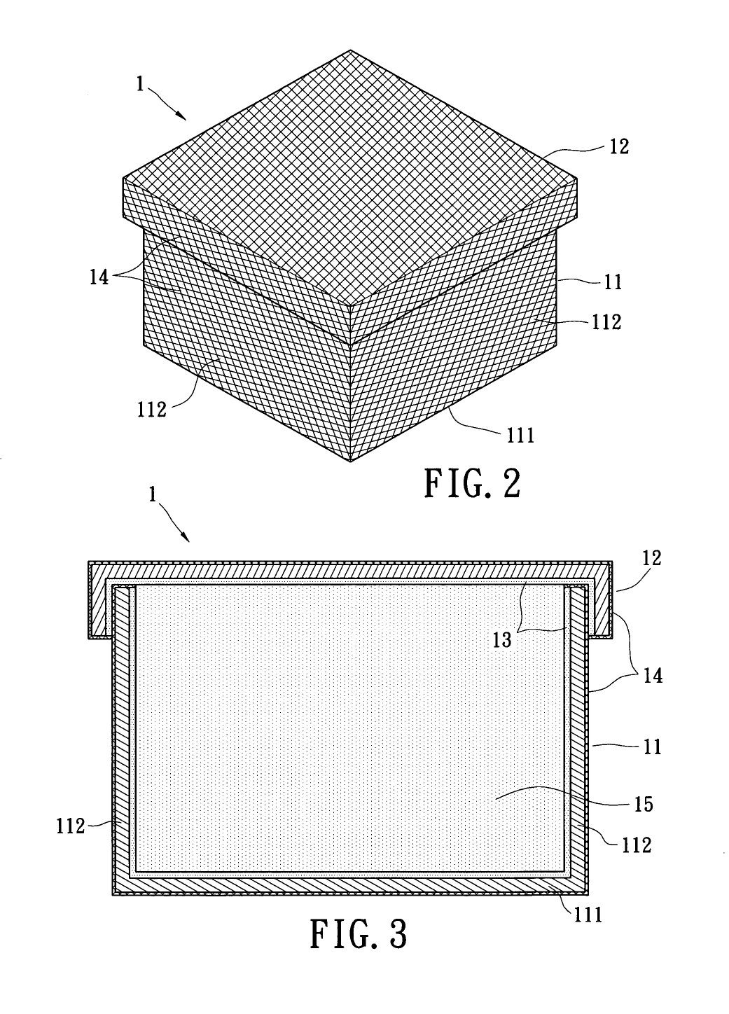

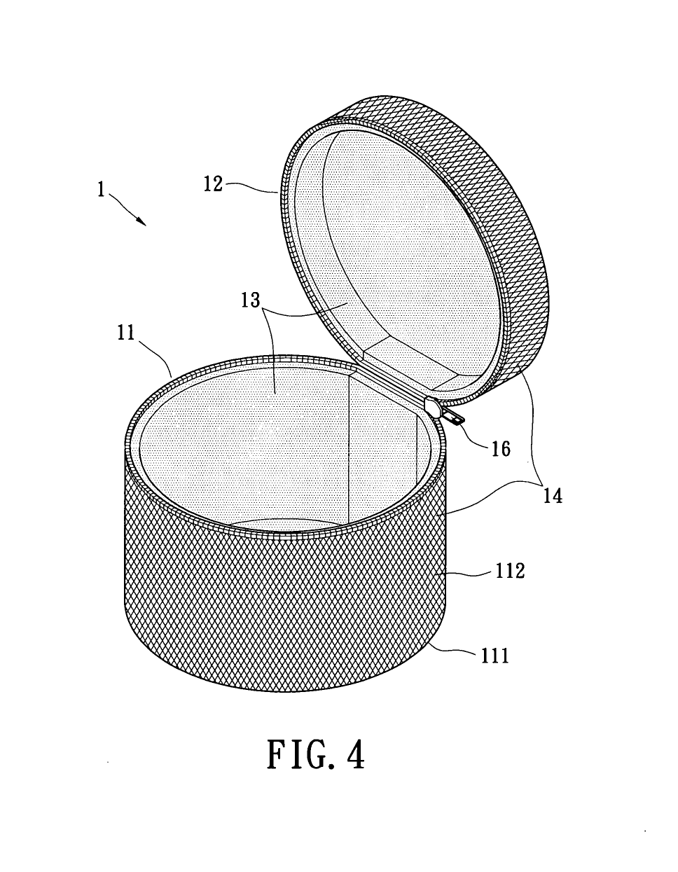

### DETAILED DESCRIPTION OF THE EMBODIMENTS

Wherever possible in the following description, like reference numerals will refer to like elements and parts unless otherwise illustrated. Referring to FIG. 1 through FIG. 3, the flameproof container 1 of the invention includes a box body 11 and a lid 12. The box body 11 had a bottom plate 111, a side plate 112 and an accommodation space 15. The bottom plate 11 can be of any shapes, as shown in FIG. 4. In this embodiment, the bottom plate 111 is rectangular and the side plate 112 extends from one side of the bottom plate 111. The accommodation space 15 is formed between the bottom plate 111 and the side plate 112. The accommodation space 15 is used to hold small delicate or valuable goods. The lid 12 covers on the box body and can be of any shapes such as rectangular or circular, as shown in FIG. 4. In this embodiment, the lid 12 can be rectangular.

The box body 11 and the lid 12 respectively have an inner cushion 13 which can be made of any material. An outer cladding 14 cover each of the box body 11 and the lid 12. The outer cladding 14 can be a flameproof cloth. The box body 11 and the lid 12 are made of flameproof material so that the container having the box body 11 and the lid 12 can be flameproof and have light weight and low cost. The flameproof and flameproof cloth utilize the fibers which are hard to be flamed so that they offers features such as long-term flame resistance, no drops when melt, and no toxic smokes. That means the flameproof material and the flameproof cloth stop burning or flaming when the fire source is kept away from them. Commercially available flameproof material is for example acrylic oxide fibers, cotton fibers, polyester fibers, modified acrylic fibers, polyamide fibers, oxidized fibers and the others that shrink, soften, carbonated without generating any black smokes as soon as become close to the fire source. For example, Nomax, Kevlar, Dupon, which tolerates up to 200-3000□. In this embodiment, the inner cushion 13 consists of 20%-50% Nomax flameproof material, tolerating up to 250□. The material used to make the box body 11 and the lid 12 are further breathable and tolerates up to 1000□. The material used to make the outer cladding 14 consists of Nomax material, aluminum, glass fiber, silicon dioxide, which tolerates up to 3000□.

FIG. 4 is a schematic view of a flameproof container according to another embodiment of the invention. The flameproof container 1 includes a box body 11 and a lid 12. One side of the lid 12 is pivotally connected to one side of the box body 11. A suspender 16 such as a zip is connected between the lid 12 and the box body 11 to lead the lid 12 to leave or cover the box body 11.

The box body 11 and the lid 12 are made of flameproof material and respectively have an inner cushion therein. The outer cladding 14 is a flameproof cloth, offering the flameproof container a significant anti-fie effect.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A flameproof container, comprising:
a box body, with an accommodation space therein, wherein the box body is made of a flameproof material; and
a lid, covering the box body, wherein the lid is made of the flameproof material, the flame proof material being formed at least partially by a material selected from the group consisting of: NOMAX, KEVLAR, and DUPON;
wherein the box body and the lid respectively have an inner cushion therein, and an outer cladding cover the box body and the lid, and wherein the outer cladding is formed of a flameproof cloth.

2. The flameproof container of claim 1, wherein the box body further comprises a bottom plate, the bottom plate being rectangular or circular, a side plate extending from one side of the bottom plate, and the accommodation space being formed between the bottom plate and the side plate.

3. A flameproof container, comprising:
a box body, with an accommodation space therein, wherein the box body is made of a flameproof material; the flameproof material being formed at least partially by a material selected from the group from the group consisting of: NOMAX, KEVLAR, and DUPON; and
a lid, one side of which is pivot joined to one side of the box body, wherein a suspender is connected between the lid and the box body to lead the lid to open or cover the box body, the lid being made of flameproof material; wherein the box body and the lid respectively have an inner cushion therein, and an outer cladding cover the box body and the lid, and wherein the outer cladding is a flameproof cloth.

4. The flameproof container of claim 3, wherein the box body further comprises a bottom plate, the bottom plate being rectangular or circular, a side plate extending from one side of the bottom plate, and the accommodation space being formed between the bottom plate and the side plate.

5. The flameproof container of claim 1, wherein the flameproof cloth is greater in temperature tolerance than the flameproof material of the box body.

6. The flameproof container of claim 5, wherein the flameproof cloth is formed at least partially of NOMAX material.

7. The flameproof container of claim 1, wherein the inner cushion, the flameproof material, and the flameproof cloth are formed to be of progressively increasing temperature tolerance.

8. The flameproof container of claim 3, wherein the flameproof cloth is greater in temperature tolerance than the flameproof material of the box body.

9. The flameproof container of claim 8, wherein the flameproof cloth is formed at least partially of NOMAX material.

10. The flameproof container of claim 3, wherein the inner cushion, the flameproof material, and the flameproof cloth are formed to be of progressively increasing temperature tolerance.
